(19) United States
(12) Patent Application Publication
(10) Pub. No.: US 2005/0041926 A1
(43) Pub. Date: Feb. 24, 2005

(54) Panel assembly with dense fiber output array

(76) Inventors: Robert B. Elkins II, Hickory, NC (US); Todd E. Mitchell, Fort Worth, TX (US); Jacqueline A. Oley, Fort Worth, TX (US); Daniel S. McGranahan, Fort Worth, TX (US); Lars K. Nielsen, Denver, NC (US)

Correspondence Address: CORNING CABLE SYSTEMS LLC, P O BOX 489, HICKORY, NC, 28603, US

(21) Appl. No.: 10/955,152

(22) Filed: Sep. 30, 2004

Related U.S. Application Data
(63) Continuation-in-part of application No. 10/288,840, filed on Nov. 6, 2002.
Application No. 10/288,840 is a continuation-in-part of application No. 09/681,603, filed on May 7, 2001, now abandoned.

(51) Int. Cl. G02B 6/36

(52) U.S. Cl. 385/53

(57) ABSTRACT

The present invention provides for an optical waveguide panel assembly having at least one slot for slidably receiving an optical waveguide module attachment, the slot including at least one optical waveguide module attachment with an outer surface having channels for receiving the side edges of the slot. In one embodiment, the slot includes a plurality of optical waveguide module attachments such that successive optical waveguide module attachments are stacked over a preceding optical waveguide module attachment. The optical waveguide module attachments may be separated by one or more spacers. Also provided for is an optical waveguide panel assembly having a plurality of slots, each slot containing a plurality of optical waveguide module attachments, thus forming a dense optical fiber output array.

### RELATED APPLICATIONS

This is a continuation-in-part of U.S. patent application Ser. No. 10/288,840 filed on Nov. 6, 2002, which is a continuation-in-part of U.S. patent application Ser. No. 09/681,603 filed on May 7, 2001, the contents of which are relied upon and incorporated herein by reference in their entirety.

### BACKGROUND OF THE INVENTION

1. Field of the Invention

The invention relates generally to optical panel assemblies. More specifically, the invention relates to a panel assembly having a dense fiber output array.

2. Technical Background

Fiber optic components, such as coupler modules, splice modules, multiplexers and de-multiplexers and the like, typically utilize connector adapters mounted on panels. Such panels often comprise a panel assembly within which the component is contained. In other cases, the panel may be a simple partition or wall behind which the component may reside and which must be breached by one or more optical waveguides to gain access to the component. Connector adapters are designed to receive an optical waveguide terminated with an optical waveguide connector. Such adapters are preferably designed to receive at least two connectors, one on either side, so that the optical waveguide disposed in one connector can mate with an optical waveguide disposed in an opposing connector. Thus, the adapter serves to facilitate the mating of one optical waveguide to another optical waveguide. Such an adapter may include a plurality of openings for receiving multiple connector pairs. Each connector may include one optical waveguide each, or they may include a plurality of optical waveguides, such as would be found in an optical fiber ribbon. However, because adapters are relatively large and bulky, the density with which optical waveguides may be connected to the panel assembly is limited. An example of a prior art adapter-connector combination is shown in FIG. 1.

Alternatively, non-connectorized leads, called pig-tails, may also be used to provide an input or output to the device through a panel assembly. These pigtails are typically held in place with a cable tie or an adhesive. Cable ties and adhesive, when used as strain relief, are craft-sensitive, and not known to perform well under adverse environmental conditions. Moreover, with the growing trend toward dense arrays of optical fibers in outdoor environments, traditional practices of employing adapters or pigtails becomes impractical when attempting to feed a multitude of optical fibers through a panel in a panel assembly. Thus, there is a need for a panel assembly which can accommodate a dense array of feed-through optical waveguide module attachments which obviate the deficiencies of connectors and adapters.

### SUMMARY

In one broad aspect, an optical waveguide panel assembly is provided comprising a panel defining at least one slot, and a plurality of optical waveguide module attachments, each optical waveguide module attachment including a one-piece body having a longitudinal passage therethrough, a clamping element configured for engaging the one-piece body, at least one channel on an outside surface of the one-piece body for slidably engaging with the slot, the channels being substantially perpendicular to the longitudinal passage, and wherein the plurality of optical waveguide module attachments are disposed within the slot such that each successive optical waveguide module attachment is stacked over a preceding optical waveguide module attachment. The panel assembly according to one embodiment includes a plurality of slots. The one-piece body may include a first and second cantilevered portion that can be deflected toward each other to provide a clamping force. Preferably, the clamping element is a crimp ring. However, the clamping element may be heat shrink tubing or other suitable member for securing strength fibers to the body.

The plurality of optical waveguide module attachments may be secured within the at least one panel slot by a cover panel.

In a preferred embodiment, the one-piece body includes a peripheral ridge about an outside surface of the body for retaining a strain relief boot. The optical waveguide module attachment may further have an outside surface including a plurality of gripping features for securing strength fibers between the body and the clamping element. The gripping features may include peripheral grooves, but may also be any other surface feature which provides increased gripping strength (e.g. surface area) for retaining the strength fibers, such as ridges or bumps.

A least one optical fiber is preferably disposed within the longitudinal passage of the body and extends from both the forward and rearward ends of the body. The at least one optical fiber may be a single optical fiber, or a group of optical fibers, such as an optical fiber ribbon.

In some embodiments of the invention, a cushioning element configured for placement about the at least one optical waveguide fiber is provided, thereby protecting the at least one optical waveguide from clamping forces which may be applied by the clamping element. A crimp tube may also be provided to secure the at least one optical fiber within the body.

If desired, a spacer may be disposed within the panel slot or slots to separate otherwise adjacent optical waveguide module attachments, such as between two optical waveguide module attachments.

In another embodiment, a panel assembly having at least one slot is provided, the panel assembly further including a plurality of optical waveguide module attachments, each optical waveguide module attachment having a one-piece body with a longitudinal passage therethrough, the one-piece body including a first portion, a third portion and a second portion disposed between the first portion and the third portion, the first portion having at least one attachment feature configured for mounting the body to the panel, and the second portion comprising a plurality of gripping features on an outside surface thereof for securing strength fibers, and wherein the third portion may be crimped to secure at least one optical waveguide fiber to the body.

The optical waveguide panel assembly preferably further includes a clamping element for securing strength fibers between the second portion of the body and the clamping element, and in some cases may also include a cushioning element for protecting the optic waveguide fiber from clamping forces. A boot configured for attachment with the body may also be used, the boot having a bend relief portion for preventing the optical waveguide fiber from undergoing excessive bending which may cause the fiber to break. At least one optical fiber may be disposed within the optical waveguide module attachment body passage, the at least one optical fiber extending from the ends of the attachment body, both the first, or front end, and the second, or back end.

In still another preferred embodiment according to the present invention, an optical waveguide panel assembly is provided, with a panel having at least one slot, a plurality of optical waveguide module attachments, each optical waveguide module attachment including a one-piece body having a longitudinal passage therethrough, a clamping element configured for engaging the one-piece body, a mounting feature on an outside surface of the one-piece body configured for mounting the optical waveguide module attachment in the slot, wherein the plurality of optical waveguide module attachments are disposed within the slot such that each successive optical waveguide module attachment is stacked over a preceding optical waveguide module attachment. The mounting feature may comprise two spaced apart flanges configured for slidably engaging with the slot.

The invention will be understood more easily and other objects, characteristics, details and advantages thereof will become more clearly apparent in the course of the following explanatory description, which is given, without in any way implying a limitation, with reference to the attached figures.

### BRIEF DESCRIPTION OF THE DRAWINGS

FIG. 1 is an illustration of a prior art method of connecting an optical waveguide with a fiber optic component through the use of an optical fiber connector adapter and a plurality of optical fiber connectors.

FIG. 2 is a perspective view of an optical waveguide panel assembly having at least one panel attachment slot for mounting an optical waveguide module attachment according to an embodiment of the present invention.

FIG. 3 is a close-up view of exemplary optical waveguide module attachments according to an embodiment of the present invention, inserted into a panel attachment slot.

FIG. 4 is a partial sectional view, partial side view of another optical waveguide module attachment disposed in a panel attachment slot according to an embodiment of the present invention.

FIG. 5 is a partially exploded perspective view of the optical waveguide module attachment of FIG. 4.

FIG. 6 is a perspective view of the body of the optical waveguide module attachment of FIG. 4.

FIG. 7 is an exploded perspective view of another optical waveguide module attachment according to the present invention.

FIG. 8 is a partially exploded, partially assembled, perspective view of another embodiment of the optical waveguide module attachment according to the present invention.

FIG. 9a is a partially exploded perspective view of another optical waveguide module attachment for ribbon according to an embodiment of the present invention.

FIGS. 9b-9d are respectively a perspective view, an elevation view, and a cross-sectional view of a portion of the optical waveguide module attachment of FIG. 9a.

FIG. 10 is a partially exploded, partially assembled, perspective view of another optical waveguide module attachment according to the present invention.

FIG. 11 is a partially exploded, partially assembled, perspective view of another optical waveguide module attachment according to the present invention.

FIG. 12 is a partially exploded, partially assembled, perspective view of another optical waveguide module attachment according to the present invention.

FIG. 13 is a partial assembled cross-sectional view of the optical waveguide module attachment of FIG. 12.

FIG. 14 is a perspective view of a another optical waveguide module attachment according to the present invention

FIG. 15 is a longitudinal cross section of the body of the optical waveguide module attachment of FIG. 16.

FIG. 16 shows a perspective view of a panel assembly having a plurality of optical waveguide module attachments arranged in dense arrays.

FIG. 17 is a perspective view of another embodiment of an optical waveguide module attachment according to the present invention.

FIG. 18 is a perspective view of the module attachment of FIG. 17 including heat shrink tubing.

FIG. 19 is a perspective view of another embodiment of an optical waveguide module attachment according to the present embodiment similar to the module attachment of FIG. 17 with rounded shoulders or flanges.

FIG. 20 is a perspective view of the module attachment of FIG. 19 including heat shrink tubing.

### DETAILED DESCRIPTION

FIG. 2 illustrates an exemplary panel assembly 10 according to an embodiment of the present invention. As shown in FIG. 2, panel assembly 10 includes a plurality of panels, including front panel 12. Panel assembly 10 may contain therein any of a variety of fiber optic components, including, but not limited to, couplers, dispersion compensating modules, multiplexers and de-multiplexers, transmitters, receivers and so forth. It will be recognized that, although the present embodiment describes a panel assembly defining an enclosure, the present invention is more generally directed to any assembly of one or more panels having a dense array of pass-through optical waveguide module attachments, and is therefore not limited to use in an enclosure only. Although illustrated as a fully enclosed assembly in FIG. 2, panel assembly 10 may be open on one or more sides. In accordance with the present embodiment, one or more panels of panel assembly 10 include at least one panel attachment slot 14 in which an optical waveguide module attachment may be mounted. Alternatively, panel attachment slot 14 may be included in one or more sub-panels which may comprise a panel, such as panel 12, of panel assembly 10. Panels such as panel 12 can also rotate so that the craftsman can easily access the inside of an enclosure.

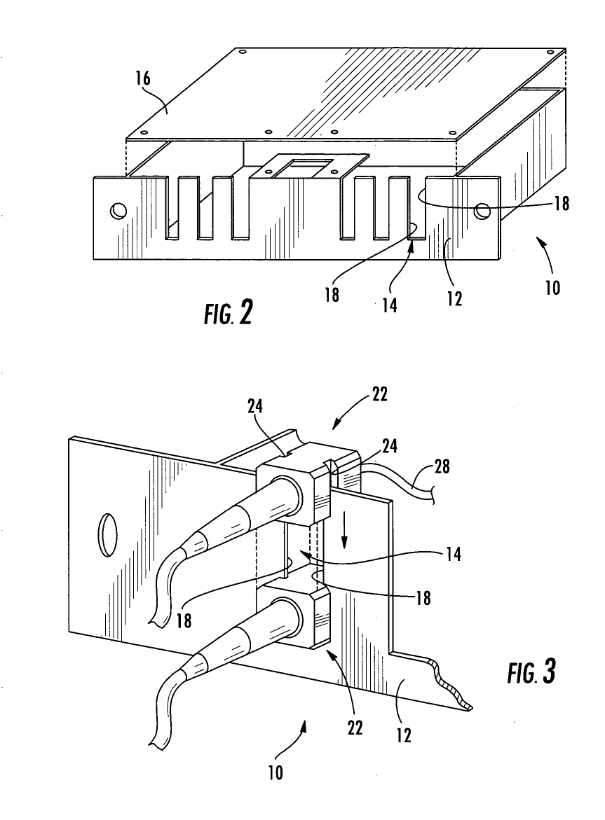

In accordance with the embodiment shown in FIG. 2, cover 16 provides access to the illustrated panel assembly, and may be secured to the rest of the assembly of panels by screws (not shown), or other fastening methods as are known in the art. Panel attachment slot 14 has at least one side edge 18. Preferably, slot 14 has two side edges 18. At least one optical waveguide module attachment 22 (FIG. 3) is inserted into panel attachment slot 14 such that side edges 18 slidably engage with at least one channel 24 formed in an outside surface of optical waveguide module attachment 22. Channel 24 may extend about the periphery of optical waveguide module attachment 22, or channel 24 may extend over only a portion of optical waveguide module attachment 22. There may be more than one channel 24. Preferably, panel attachment slot 14 is sized to accommodate a plurality of optical waveguide module attachments 22. In the case where a plurality of optical waveguide module attachments are disposed within slot 14, each subsequent optical waveguide module attachment is stacked over a preceding optical waveguide module attachment to form a dense linear output array. Alternatively, separation between otherwise adjacent optical waveguide module attachments may be desired, and can easily be accomplished by inserting blanks or spacers (not shown) between consecutive optical waveguide module attachments. Thus, a spacer may be used to separate two optical waveguide module attachments. By blanks or spacers what is meant is a dummy optical waveguide module attachment (i.e. which contains no optical fibers), or a portion thereof, which includes attachment features necessary for the dummy optical waveguide module attachment to engage with slot 14. A dummy optical waveguide module attachment could comprise, for example, only the minimum structure necessary to perform attachment and spacing functions. For instance, a simple block or cylindrical shape having at least one channel for slidably engaging with slot 14 would serve as a suitable spacer. Panel assembly 10 may contain a plurality of panel attachment slots 14, each slot 14 containing a plurality of optical waveguide module attachments 22. Each slot may also contain one or more spacers as needed.

An exemplary optical waveguide module attachment 22 according to one embodiment of the present invention is illustrated in FIG. 3 being mounted in panel attachment slot 14 over a first optical waveguide module attachment. At least one optical waveguide 28 such as a single optical fiber for example, enters panel assembly 10 through panel 12 via optical waveguide module attachment 22. In other embodiments, the at least one optical waveguide may comprise one of a plurality of optical fibers or is a portion of an optical fiber ribbon.

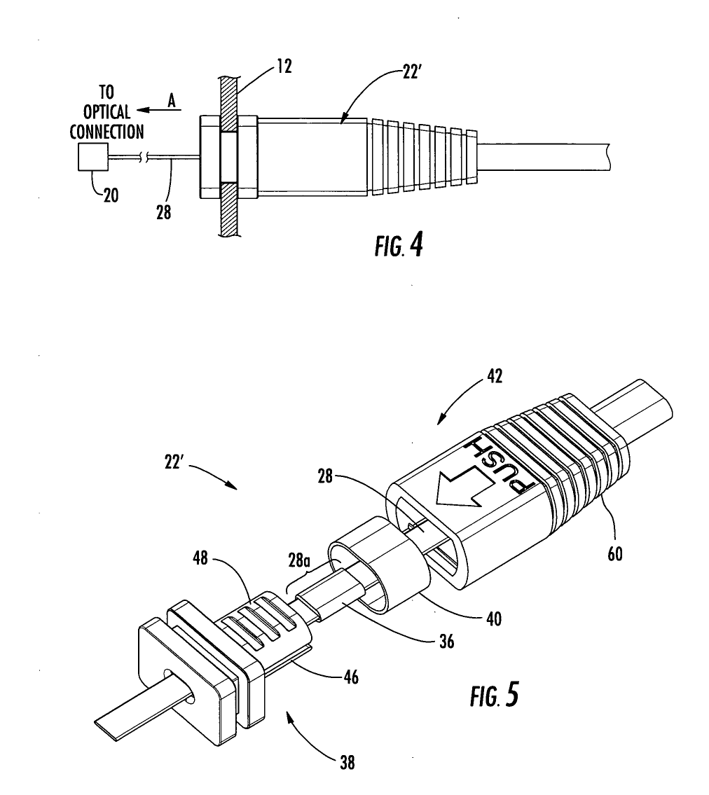

For instance, FIG. 4 depicts a portion of panel 12 of the panel assembly, as seen from the top, providing a mounting location for optical waveguide module attachment 22′ suitable for securing an optical fiber ribbon. By way of example, an application may require optical fibers in a ribbon structure to optically connect with a fiber optic component on one side of a panel, as depicted by arrow A, using optical connector 20. However, the application typically may further require that external forces such as tension loads not be transferred by optical waveguides(s) 28 to the optical components/connections within the panel assembly. Optical waveguide module attachments according to the present invention secure the at least one optical waveguide fiber, such as one or more optical fibers and/or optical fiber ribbons, that enters a panel assembly and inhibit external forces from being transferred past the optical waveguide module attachment to the fiber optic components mounted therein. Preferred embodiments of the present invention generally eliminate the need for epoxies and/or adhesives; however, the same may be used with the concepts of the present invention.

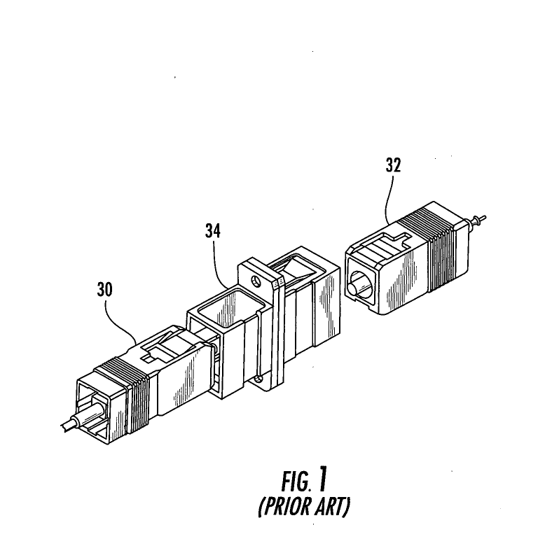

Additionally, the present invention should not be confused with optical connectors that optically couple optical waveguide fibers, such as those indicated in FIG. 1. The panel connection components shown in FIG. 1 include a first optical fiber connector 30, a second fiber optic connector 32 and adapter 34 for joining together first and second connectors 30, 32. Instead, optical waveguide module attachments of the present invention secure at least one optical waveguide fiber at a medial portion thereof, wherein a length of optical fiber extends from both ends of the attachment. Typically, the length of optical fiber extending from both ends of the optical waveguide module attachment exceeds at least about 1 cm, more typically at least about 10 cm. Additionally, preferred embodiments of the present invention secure optical waveguides in a clamping zone of an optical waveguide module attachment body; however, other additional components such as strength members can be secured, thereby providing a robust configuration.

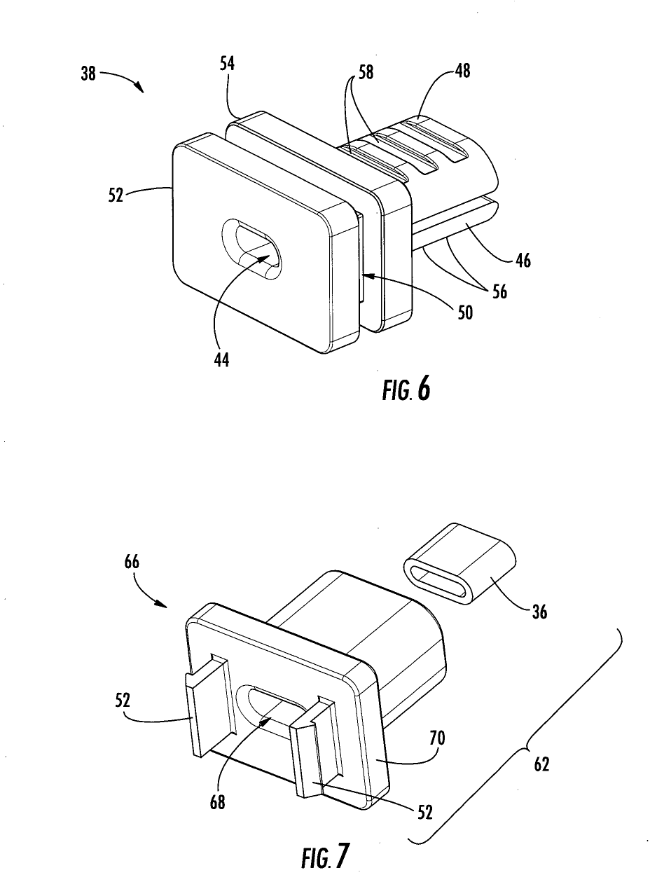

FIG. 5 illustrates a partially exploded perspective view of optical waveguide module attachment 22′. Optical waveguide module attachment 22′ includes a cushioning element 36, a body 38, a clamping element 40, and a boot 42. In use, cushioning element 36 is positioned about a predetermined portion of at least one optical waveguide fiber 28 such as a fiber optic ribbon (hereinafter ribbon), thereby forming a clamping portion 28a of optical waveguide 28. Body 38 has passage 44 therethrough (FIG. 6) that continues through to a first cantilevered portion 46 and a second cantilevered portion 48. Cantilevered portions 46, 48 form a clamping zone therebetween. Optical waveguide 28 is inserted into passage 44 from the cantilevered side until clamping portion 28a is disposed between first and second cantilevered portions 46, 48 of body 38, i.e., the clamping zone. Thereafter, clamping element 40, such as a crimp ring, engages first and second cantilevered portions 46, 48 so that portions 46, 48 are at least partially within the clamping element. The clamping element can then be clamped, such as by crimping with a suitable tool as is known in the art, so that cantilevered portions 46, 48 are biased together, thereby securing the optical waveguide fiber by applying a clamping force to clamping portion 28a that inhibits relative movement between body 38 and optical waveguide 28.

Cushioning element 36 preserves optical performance of optical waveguide 28 by providing a relatively soft cushioning/compressible material between optical waveguide 28 and the clamping element 40. Preferably, cushioning element 36 is formed from a resilient material. Thus, when the clamping force is applied it is more uniformly distributed to optical waveguide 28. Cushioning element 36 has predetermined dimensions so that it fits about the selected optical waveguide 28, but still can fit within the clamping zone of cantilevered portions 46, 48. In other embodiments, cushioning element 36 can be sized for placement about a plurality of optical waveguides such as ribbons or bundles. Preferably, cushioning element 36 is an elastomeric material such as Krayton® formed as a collar that slides over optical waveguide 28; however, other suitable shapes and/or materials such as a collar having a slit can be used. Moreover, cushioning element 36 is only required on that portion of the optical waveguide where force is directly applied; however, preferred embodiments use a cushioning element over the length of the optical waveguide 28 portion experiencing clamping forces.

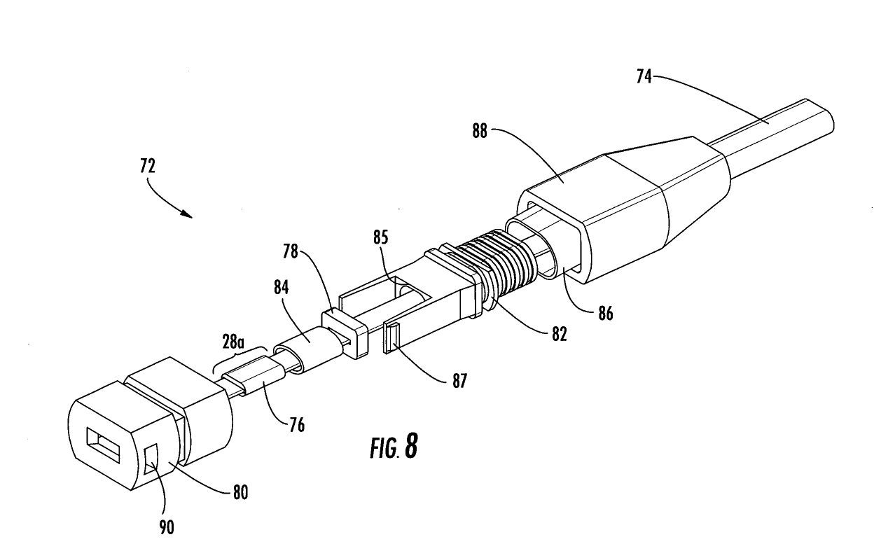

As depicted in FIG. 6, body 38 includes passage 44 and an attachment feature 50. As shown in FIG. 6, attachment feature 50 comprises at least one channel formed by spaced apart flanges 52, 54, channel 50 extending about the periphery of body 38 between flanges 52, 54. Body 38 can use suitable materials for portions thereof such as dielectrics, metals, composite materials or combinations thereof. For instance, a metal body can be machined using known machining techniques or a dielectric material can be injected molded. Passage 44 has predetermined dimensions for receiving at least one optical waveguide 28 therethrough; however, the dimensions of passage 44 can be configured for more than one optical waveguide fiber, such as one or more ribbons to extend therethrough. As depicted, this embodiment includes first cantilevered portion 46, and second cantilevered portion 48 extending from body 38. Cantilevered portions 46, 48 are spaced apart so that clamping portion 28a may fit therebetween. Additionally, the clamping zone of passage 44 can have inner surface features such as teeth, rings, or bumps, thereby providing resistance to movement of the optical waveguide fiber clamped between cantilevered portions 46, 48. Attachment feature 50 is used for mounting body 38, for example, in slot 14. As illustrated in FIG. 6 and previously discussed, attachment feature 50 comprises a channel formed between flanges 52 and 54, and extending about the periphery of body 38. However, attachment feature 50 may comprise more than one channel and which plurality of channels need not extend completely about the periphery of body 38. Such an arrangement may be applied to other geometric shapes as well, such as a circular or cylindrical body portions (e.g. circular flanges). For applications other than providing a dense output array, such as mounting singly, other suitable attachment features may also be used such as a resilient member 52 (FIG. 7) for securing the body to a mounting location. Other attachment features can include a single mounting flange, or shoulder, that is screwed to a panel.

Cantilevered portions 46, 48 may additionally include one or more surface features such as grooves 56 (not shown), 58 on an outside surface of cantilevered portions 46, 48 for securing strength members (not shown) of a fiber optic cable. By way of example, a fiber optic cable can have a portion of its jacket and strength members removed. Thereafter, cushioning element 36 is mounted on optical waveguide 28, located at clamping portion 28a and thereafter inserted between cantilevered portions 46, 48. The portions of the strength members which remain are attached to the cable and disposed generally on the outer surfaces of cantilevered portions 46, 48, preferably adjacent surface features 56, 58. When clamping element 40, such as a crimp ring, engages cantilevered portions 46, 48 the strength members are trapped between the clamping element and the cantilevered portions. Consequently, when crimp ring 40 is crimped the strength members are secured to body 38. Thus, forces applied to the fiber optic cable are transferred to body 38 through the strength members and then to the mounting surface of the optical waveguide module attachment, rather than to the optical components/connections within the panel assembly.

Optical waveguide module attachment 22′ may also include boot 42 (FIG. 5) for providing additional strain relief to the optical fiber, optical fiber ribbon and/or optical fiber cable. Boot 42 can be formed from any suitable material such as polymeric materials. Boot 42 preferably has a bend relief portion 60 (FIG. 2) and is configured for attachment with body 38 using suitable means such as a friction fit, resilient members, or adhesives. Additionally, other bend relief elements can be used such as a heat shrink sleeve.

The concepts of the present invention can be practiced in other embodiments. For instance, depicted in FIG. 7 is optical waveguide module attachment 62. Optical waveguide module attachment 62 includes a cushioning element 36 and a body 66. Body 66 includes a passage 68 therethrough and an optional attachment feature 52. Cushioning element 36 fits about optical waveguide 28, thereby forming clamping portion 28a. Cushioning element 36 may include a slit (not shown) to aid in the application of the cushioning element to an optical waveguide. Passage 68 has predetermined dimensions suitable for inserting the clamping portion 28a within passage 68. In this embodiment, body 66 also functions as a clamping element. In other words, after clamping portion 28a is in position relative to passage 68, body 66 can be crimped, thereby applying a clamping force to clamping portion 28a to secure the same. Additionally, in this embodiment a per se attachment feature 52 and/or flange 70 are not necessary. Stated another way, the outer surface of body 66 can function as an attachment feature having a locking or friction fit. For example, body 66 can be secured by trapping end faces in a lengthwise direction or by using the transverse cross-sectional outer surface as a friction-fit within an aperture. However, as depicted, body 66 includes at least one resilient member 52 that is deflected during installation and is biased outward after full insertion into a suitably sized aperture, thereby securing body 66 within the aperture. However, any other suitable attachment features can be used such as quarter-turn locking features. Moreover, body 66 can be formed from any suitable materials.

FIG. 8 illustrates another embodiment according to the present invention. Optical waveguide module attachment 72 is intended to secure a cable 74 thereto. Optical waveguide module attachment 72 includes a cushioning element 76, a retainer 78, a housing 80, a spring push 82, a body 84; a clamping element, such as crimp ring 86, and a boot 88. As described in the previous embodiment, body 84 is capable of applying a clamping force to clamping portion 28a, thereby securing the optical waveguide. In this particular embodiment, the end faces of body 84 are trapped between retainer 78 and an internal surface (not shown) of housing 80.

During assembly, a suitable portion of the jacket and strength members of cable 74 are stripped therefrom and boot 88, crimp ring 86, spring push 82, retainer 78, and cushioning element 76 are pushed onto the ribbon/cable. Next, cushioning element 76 is located at clamping portion 28a and body 84 is secured thereto. Thereafter, retainer 78 can be positioned to abut the rear face of body 84 and a backstop surface 85 of spring push 82 abuts the other side of retainer 78. The strength members of cable 74 are then positioned on the grooved portion of spring push 82. Thereafter, crimp ring 86 is positioned thereover and crimped, thereby providing strain relief to the cable. Spring push 82 can then be removably attached to housing 80 by having resilient members 87 engage notches 90 in housing 80 in a snap-fit arrangement. Thereafter, boot 88 can be attached to the rear of spring push 82. Housing 80 can include attachment features thereon for mounting the optical waveguide module attachment. Moreover, other housings configured for a plurality of spring pushes can be used.

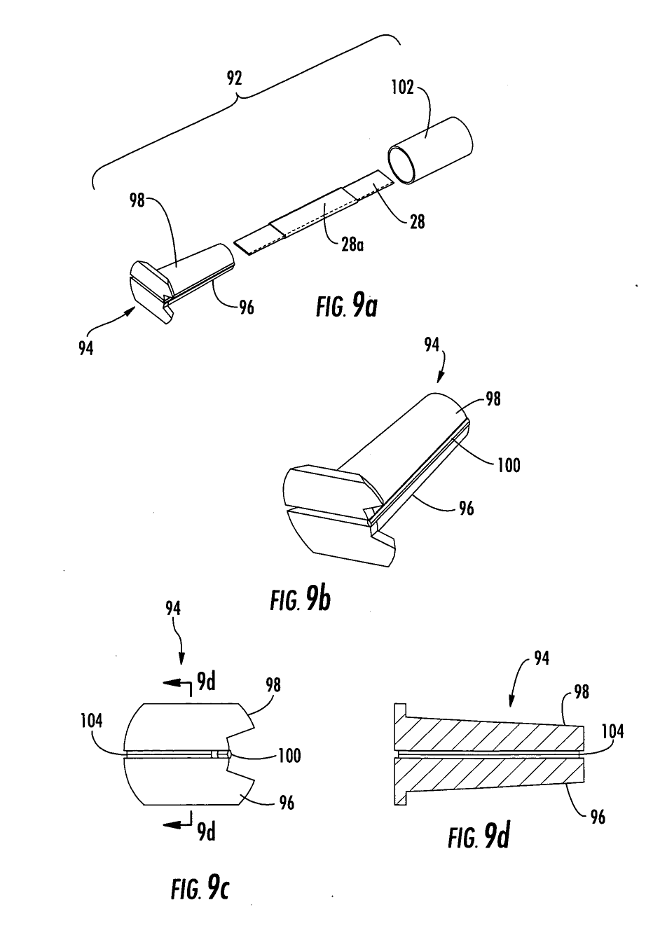

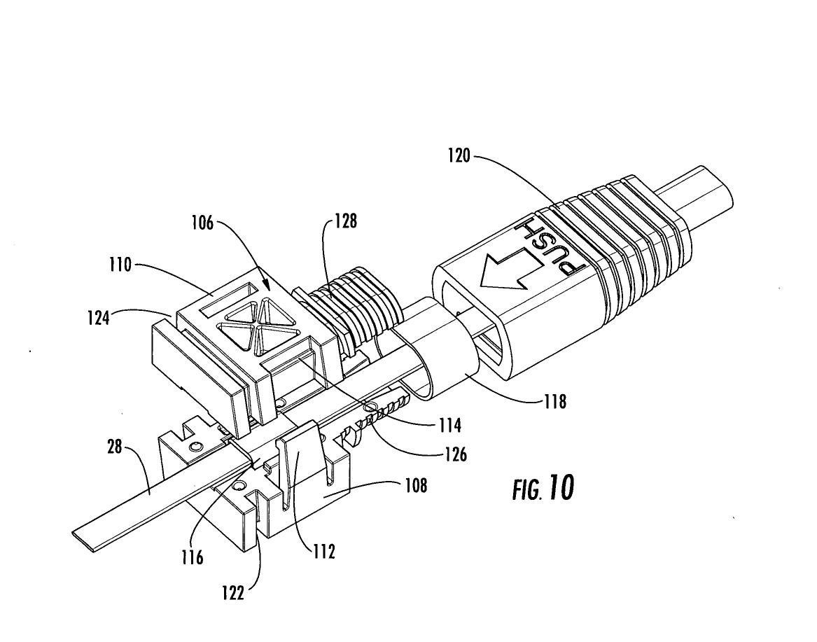

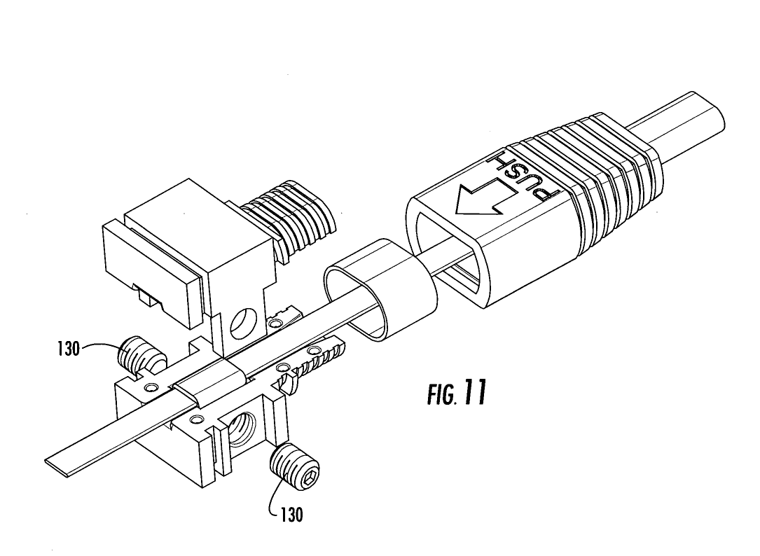

FIGS. 9a-9d illustrate concepts of optical waveguide module attachment 92 using a body 94 having hinged portions. Body 94 includes a first portion 96 and a second portion 98 with opposing surfaces connected by a hinge 100, such as a living hinge, that form a clamping zone therebetween. Clamping can be provided by clamping portion 102, or an element such as a compression sleeve, thereby securing the at least one optical waveguide 28 between hinged portions 96, 98. Furthermore, one or both of the opposing surfaces of hinged portions 96, 98 can include a cushioning element 104 thereon. Some examples include foams, rubbers, or other suitable compressible materials. Also as discussed above, positioning the cushioning element about the optical waveguide fiber is also possible. The hinged portions 96, 98 can include other suitable clamping portions that are integral with the body such as snapping tabs or resilient members; however, other components such as wire ties are suitable for securing hinged portions 96, 98 together, thereby clamping the optical waveguide fiber(s). Although the depicted embodiment includes a shoulder, other embodiments can have other suitable shapes and/or configurations.

Other suitable embodiments include hinged portions having profiles other than generally planar. For example, profiles in a plastic hinge body can form a cylindrical passage through the same, thereby allowing clamping of a bundle of optical waveguides. Additionally, other configurations can include first and second portions not hinged together.

FIG. 10 illustrates exemplary concepts of a body 106 including first and second portions 108, 110 that engage each other. As shown, first portion 108 includes at least one resilient portion 112 that cooperates with a respective notch 114 formed on second portion 110, thereby securing at least one optical fiber in a clamping zone between the portions. Moreover, the first and second portions 108, 110 can include alignment features (not numbered). Like other embodiments, cushioning elements 116 can be placed in any suitable location and/or the first and second portions can have profiled surfaces for bundles as well as generally planar surfaces for optical waveguides such as optical fibers/ribbons.

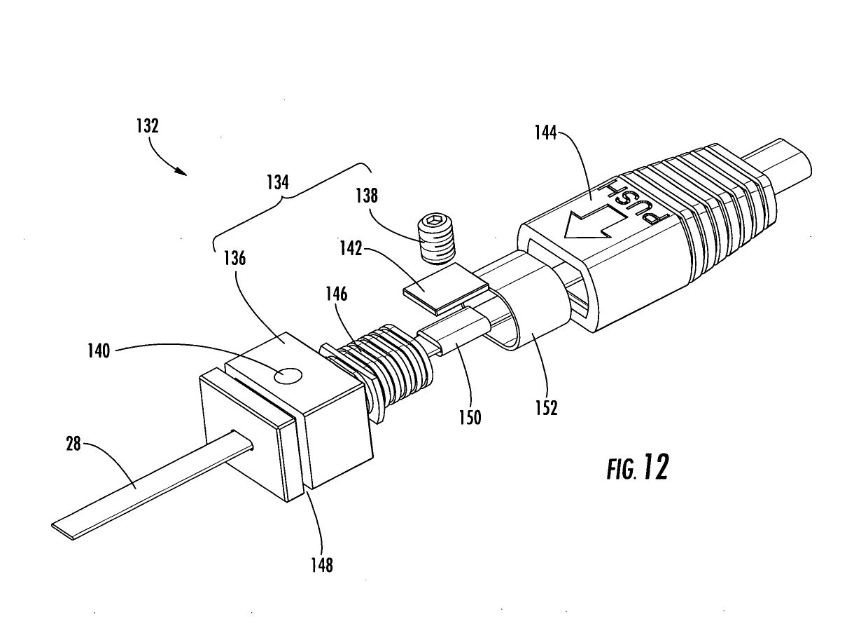

In other embodiments, clamping forces can be applied using a clamping element 118 such as a crimp ring. Other embodiments could use both integral and discrete clamping portions for applying clamping forces. Additionally, embodiments shown and variations thereof can include a boot 120 for bend relief, attachment features 122, 124 for securing body 106 to a panel or other mounting location, or grooves 126, 128 for securing strength members for strain relief. Illustrated in FIG. 11 is an embodiment that is similar to FIG. 10, except that FIG. 11 employs a pair of screws 130 to hold the first and second portions together.

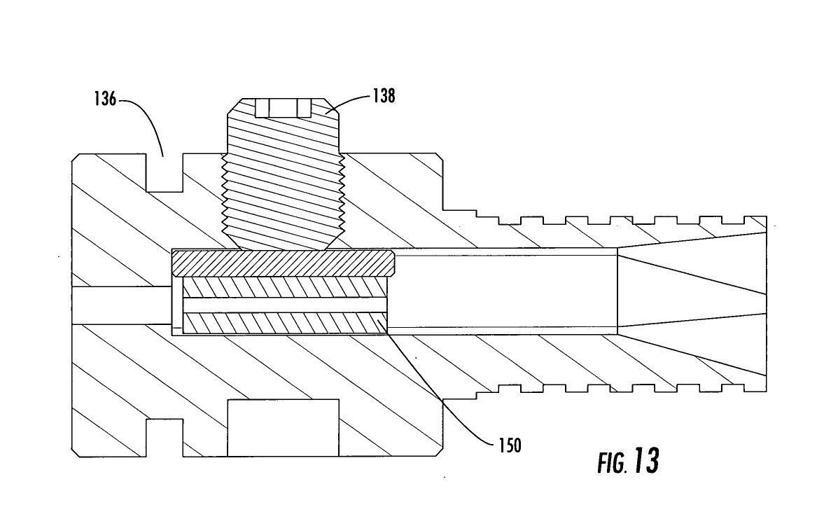

Other concepts of the present invention include other suitable clamping portions and/or elements. FIG. 12 illustrates an exemplary embodiment of optical waveguide module attachment 132 using a two-portion body 134 for advancing a clamping portion disposed in a clamping zone thereof. Specifically, body 134 includes a body block 136 and a screw 138 cooperating with a bore 140 in body block 136 that is capable of advancing a plate 142 for applying a generally uniform clamping force. Like other embodiments, variations include bend relief such as boot 144, grooves 146, attachment features 148, cushioning elements 150, and/or one or more clamping portions integral with body 134 or separate elements such as crimp ring 152. FIG. 13 depicts a partial cross-section of optical waveguide module attachment 132 of FIG. 12. As shown, the clamping force on cushioning element 150 (and therefore the clamping portion of the optical waveguide) secures the same. In other embodiments, the body can include more than two-portions.

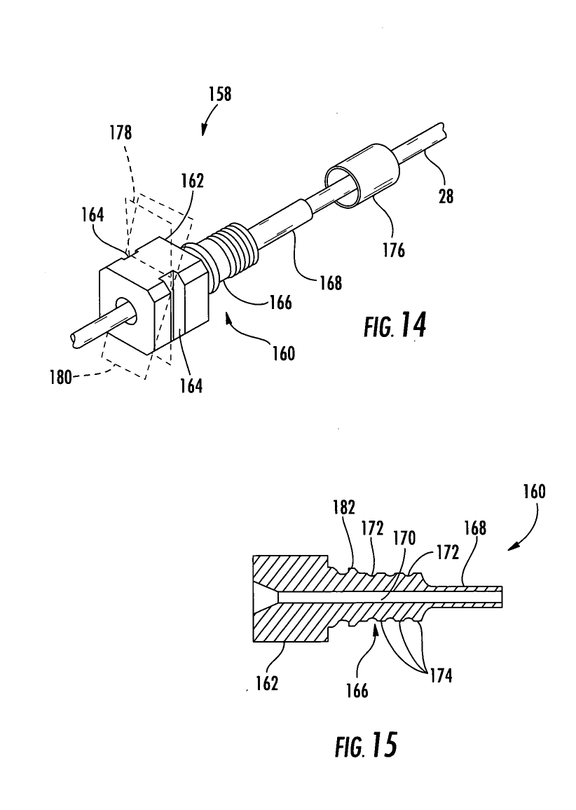

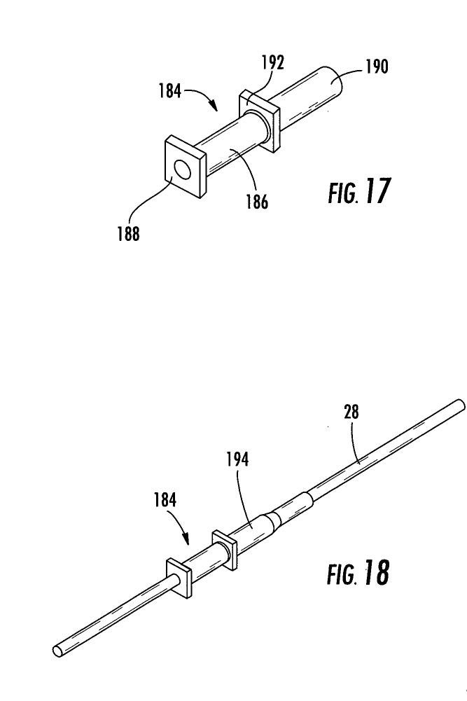

In still another embodiment illustrated in FIGS. 14 and 15, optical waveguide module attachment 158 includes a one-piece body 160 adapted for use with a single optical waveguide fiber comprising a first portion 162 having attachment feature 164, a second, medial portion 166, a third portion 168 and a passageway 170 extending through the body. Preferably, third portion 168 has a generally thin wall relative to medial portion 166 such that third portion 168 may be crimped about an optical waveguide fiber disposed within passage 170. A cross section of body 160 is shown in FIG. 17. Intermediate portion 166 may include gripping features on an outside surface of the portion, such as grooves 172, ridges 174 or both grooves and ridges. The gripping features may cooperate with a clamping element 176, such as a crimp ring, for clamping strength fibers therebetween. Other suitable surface features for retaining strength fibers related to an optical waveguide fiber or cable may also be employed. Clamping element 176 may be clamped about medial portion 166, such as by crimping the clamping element, to clamp strength fibers of a cable to medial portion 166. Alternatively, heat shrink tubing (not shown), may be used in place of clamping element 176, but is less preferred in that the clamping force from heat shrink tubing is not as great as that achievable by, for example, a metallic crimp ring. First portion 162 further comprises attachment feature 164 on the outside surface of first portion 162. Attachment feature 164 may be, for example, one or more channels, as illustrated in FIG. 14, arranged substantially perpendicular to passage 170. The channel may be used to slidably receive slot edges 18 for mounting attachment 158 in panel attachment slot 14. Although FIG. 14 depicts two channels, attachment feature 164 could consist of a single channel disposed about the entire periphery of first portion 162. Thus, a single peripheral channel could be used to mount the optical waveguide module attachment in multiple orientations. In an alternative configuration, two spaced apart flanges could be used to create a channel for mounting the optical waveguide module attachment with the same effect as a single peripheral channel. Preferably, the plane 178 of the channel or channels is substantially perpendicular to passage 170. However, the plane of the channel or channels could be oriented at an angle, such as shown by plane 180, to allow angular mounting of the optical waveguide module attachment.

Buffered optical waveguide fiber 28 may be inserted through passage 170. Third portion 168 may then be crimped about the buffered optical fiber. Alternative methods of retaining optical waveguide fiber 28 within passage 170 may be employed if desired, such as with epoxy. However, if third portion 168 is to be crimped about optical waveguide fiber 28, it is preferable that the body be comprised of metal, such as brass, bronze, copper, stainless steel, or other material suitable for crimping. Clamping element 176, previously placed overtop optical waveguide fiber 28 may be slid forward about second portion 166, and crimped onto second portion 166 to secure the strength fibers to the body. It should be understood that optical waveguide module attachment 158 may be configured to receive multiple optical waveguide fibers, such as an optical fiber ribbon. A boot (not shown), such as boot 42, also previously mounted overtop optical waveguide fiber 28, may then be slid forward overtop body 160, and in particular, overtop second, intermediate portion 166 and third portion 168, to provide additional bending relief to optical waveguide fiber 28. Preferably, the inside surface of the boot is configured to engage with peripheral ridge 182 disposed on the outside surface of intermediate portion 166 of the body. The boot preferably includes a bend relief portion as described with regard to boot 42.

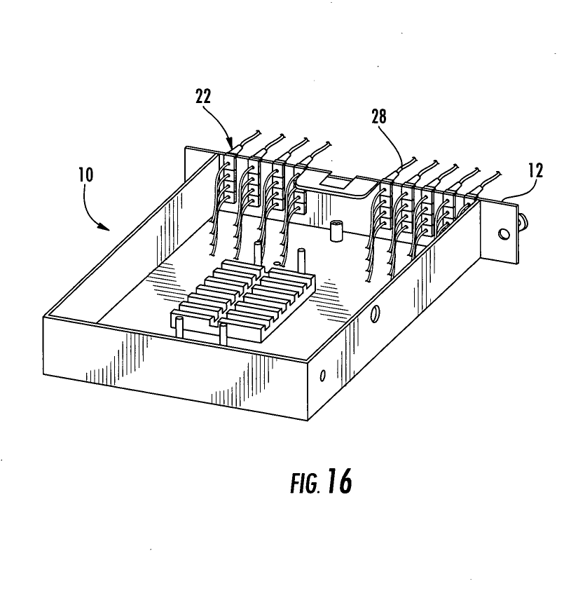

Once optical waveguide module attachment 158 has been assembled, optical waveguide 28 may be connected to the appropriate component within a panel assembly, such as panel assembly 10. For example, optical waveguide fiber 28 may be fusion spliced to a component pigtail, such as a coupler pigtail. Optical waveguide module attachment 158 may then be mounted in slot 14 as previously described. Alternatively, optical waveguide module attachment 158 may first be mounted in slot 14, after which optical waveguide fiber 28 is connected to the appropriate component. In either case, as previously described and as shown in FIG. 16, a plurality of optical waveguide module attachments may be mounted in the panel slot, such as by slidably engaging panel attachment slot edges 18 with the body attachment feature, in this instance, channels. As shown, the mounted optical waveguide module attachments may be secured within the slots by securing cover 16 (FIG. 1) overtop the slot openings in those instances where a cover is provided; however, other securement methods are possible.

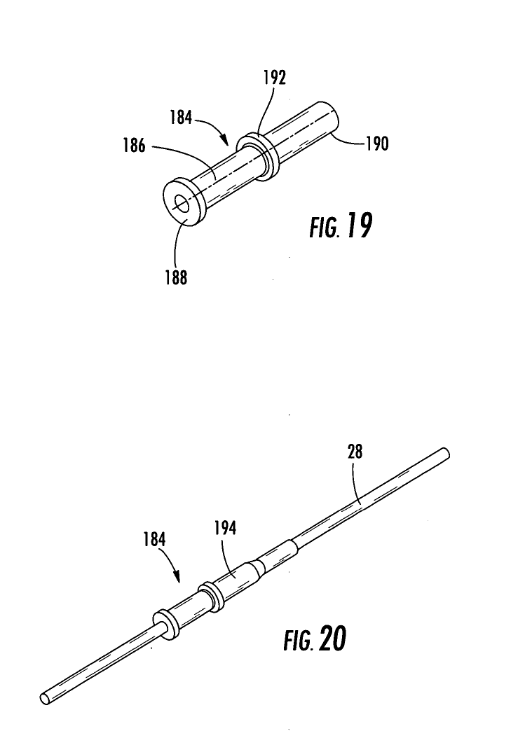

FIGS. 17 and 18 illustrate another embodiment of an optical waveguide module attachment according to the present invention. The optical waveguide used in the present embodiment may not include strength fibers, as may be the case with buffered optical fibers. The optical waveguide according to the present embodiment is preferably a single optical fiber. The attachment module of fiber crimp tube 184 has a body 186 and shoulder or flange 188. Body 186 also has a crimp end 190 and an optional second shoulder or flange 192. In the instance where optional second shoulder 192 is provided, a channel about the periphery of body 186 is formed, the channel being suitable for mounting the body in a manner such as depicted in FIG. 16, for example. Fiber crimp tube 184 is slipped over the optical waveguide and crimp end 190 is crimped or otherwise attached to optical waveguide 28. A heat shrink sleeve 194 (FIG. 18) may be shrunk over crimp end 190 and a section of optical waveguide 28 to protect and maintain an appropriate bend radius of the optical waveguide. Hence, heat shrink sleeve 194 functions as a clamping element and crimp tube 184 essentially functions as a boot. Alternatively, sleeve 194 could be shrunk over crimp end 190 without crimping such that sleeve 194 holds the section of optical waveguide to crimp tube 184. Flanges 188 and 192 are sized and dimensioned such that the channel formed therebetween may be received in corresponding grooves or structures in optical hardware, such as slot 14 in optical panel assembly 10. As shown in FIGS. 19 and 20, the flanges 188 and 192 may also be round.

Additionally, although crimp tube 184 is discussed in connection with optical waveguide 28 without strength fibers, crimp tube 184 may also be suitable for optical waveguides which include strength fibers. In this situation, crimp end 190 may be crimped over the strength fibers and the outer protective coating of the optical waveguide. It is also possible to secure the strength fibers between the crimp end 190 and the heat shrink sleeve 194.

Many modifications and other embodiments of the present invention, within the scope of the appended claims, will become apparent to a skilled artisan. For example, although optical waveguide module attachments of the present invention are disclosed as being assembled into a fiber optic panel assembly in at least one stacked array, such optical waveguide module attachments may be mounted in any other panel, wall, or partition as may be required, either singularly or in a stacked array. Therefore, it is to be understood that the invention is not to be limited to the specific embodiments disclosed and that modifications and other embodiments may be made within the scope of the appended claims. Although specific terms are employed herein, they are used in a generic and descriptive sense only and not for purposes of limitation. The invention has been described with reference to both single optical waveguide fibers and optical waveguide fiber ribbons. However, a plurality of ribbons in a stack or a buffer tube passing through the body of the optical waveguide module attachment are within the scope of the present invention. Furthermore, several ribbon stacks may be individually bundled for securing at the optical waveguide module attachment body.

1. A fiber panel assembly comprising:
a panel defining at least one panel attachment slot for mounting optical waveguide module attachments;
a plurality of optical waveguide module attachments disposed within the at least one panel attachment slot, each optical waveguide module attachment comprising:
a) a one-piece body having a longitudinal passage therethrough;
b) a clamping element configured for engaging the one-piece body; and
c) at least one channel on an outside surface of the one-piece body for slidably engaging with the panel attachment slot.

2. The optical waveguide panel assembly according to claim 1, wherein the panel assembly comprises a plurality of panel attachment slots.

3. The optical waveguide panel assembly according to claim 1, wherein the one-piece body comprises a first and second cantilevered portion, the first and second cantilevered portions are spaced apart so that they can be deflected towards each other, thereby providing a clamping force.

4. The optical waveguide panel assembly according to claim 1, wherein the clamping element is a crimp ring.

5. The optical waveguide panel assembly according to claim 1, wherein the clamping element comprises heat shrink tubing.

6. The optical waveguide panel assembly according to claim 1, wherein the plurality of optical waveguide module attachments are secured within the at least one panel attachment slot by a cover panel.

7. The optical waveguide panel assembly according to claim 1, wherein the one-piece body comprises a ridge about an outside surface of the body for retaining a boot.

8. The optical waveguide panel assembly according to claim 1, wherein the one-piece body includes an end portion having an outer diameter that is smaller than an outer diameter of a medial portion and a wall thickness of the end portion is smaller than a wall thickness of the medial portion.

9. The optical waveguide panel assembly according to claim 1, wherein an outside surface of the one-piece body comprises a plurality of gripping features.

10. The optical waveguide panel assembly according to claim 9, wherein the gripping features include at least one ridge.

11. The optical waveguide panel assembly according to claim 1, wherein the one-piece body has a forward end and a rearward end, and at least one optical waveguide fiber disposed within the passage such that the at least one optical fiber extends beyond both the forward and rearward ends by at least 1 cm.

12. The optical waveguide panel assembly according to claim 11, wherein the at least one optical waveguide fiber is a portion of an optical fiber ribbon.

13. The optical waveguide panel assembly according to claim 11, further comprising a cushioning element configured for placement about the at least one optical waveguide fiber, thereby cushioning the at least one optical waveguide fiber from clamping forces.

14. The optical waveguide panel assembly according to claim 11, further comprising a crimp tube adjacent the body for securing the at least one optical fiber.

15. The optical waveguide panel assembly according to claim 1, wherein a spacer is disposed within the at least one panel attachment slot.

16. The optical waveguide panel assembly according to claim 15, wherein the spacer separates two optical waveguide module attachments.

17. An optical waveguide panel assembly comprising:
a panel defining at least one panel attachment slot for mounting optical waveguide module attachments;
a plurality of optical waveguide module attachments disposed within the at least one panel attachment slot, each optical waveguide module attachment comprising:
a one-piece body having a longitudinal passage therethrough, the one-piece body including a first portion, a third portion and a second portion, the second portion being disposed between the first portion and the third portion, the first portion having at least one attachment feature configured for mounting the body within the panel attachment slot, the second portion comprising a plurality of gripping features on an outside surface thereof for securing strength fibers; and
wherein the third portion may be crimped for securing at least one optical waveguide fiber to the body.

18. The optical waveguide panel assembly according to claim 17, further comprising a clamping element for securing strength fibers between the second portion and the clamping element.

19. The optical waveguide panel assembly according to claim 17, wherein the third portion has an outer diameter that is smaller than an outer diameter of the second portion and a wall thickness of the third portion is smaller than a wall thickness of the second portion.

20. The optical waveguide panel assembly according to claim 17, further comprising a cushioning element for protecting the optic waveguide fiber from clamping forces.

21. The optical waveguide panel assembly according to claim 17, further comprising a boot configured for attachment with the body, the boot having a bend relief portion.

22. The optical waveguide panel assembly according to claim 17, further comprising at least one optical waveguide fiber disposed in the passage, the at least one optical waveguide fiber extending from an end of the first portion and an end of the third portion.

23. The optical waveguide panel assembly according to claim 21, wherein the optical waveguide fiber extends at least 1 cm from the ends of the first and third portions.

24. An optical waveguide panel assembly comprising:
a panel defining at least one panel attachment slot for mounting optical waveguide module attachments;
a plurality of optical waveguide module attachments mounted in the at least one panel attachment slot, each optical waveguide module attachment comprising:
a) a one-piece body having a longitudinal passage therethrough;
b) a clamping element configured for clamping strength fibers to the one-piece body; and
c) a mounting feature on an outside surface of the one-piece body configured for mounting the optical waveguide module attachment in the slot; and
at least one optical fiber disposed in the longitudinal passage.

25. The optical waveguide panel assembly according to claim 24, wherein the mounting feature comprises two spaced apart flanges configured for slidably engaging with the at least one panel attachment slot.

26. The optical waveguide panel assembly according to claim 24, wherein the one-piece body has a first, forward end and a second, rearward end, and the at least one optical waveguide fiber extends at least 1 cm from both the forward and rearward ends of the body.

27. The optical waveguide panel assembly according to claim 24, wherein the at least one optical waveguide fiber is a portion of an optical fiber ribbon.

28. The optical waveguide panel assembly according to claim 24, wherein the mounting feature comprises at least one channel in an outside surface of the one-piece body, the at least one channel being substantially perpendicular to the passage.

29. The optical waveguide panel assembly according to claim 24, wherein the one-piece body has an end portion having an outer diameter that is smaller than an outer diameter of a medial portion and a wall thickness of the end portion is smaller than a wall thickness of the medial portion.
